(19) United States
(12) Patent Application Publication
(10) Pub. No.: US 2020/0294111 A1
(43) Pub. Date: Sep. 17, 2020

(54) DETERMINING TARGET USER GROUP

(71) Applicant: Alibaba Group Holding Limited, George Town (KY)

(72) Inventor: Xiaobo Guo, Hangzhou (CN)

(73) Assignee: Alibaba Group Holding Limited, George Town (KY)

(21) Appl. No.: 16/888,533

(22) Filed: May 29, 2020

Related U.S. Application Data
(63) Continuation of application No. PCT/CN2019/072754, filed on Jan. 23, 2019.

(30) Foreign Application Priority Data
Mar. 6, 2018 (CN) 201810182272.6

(51) Int. Cl. G06Q 30/06; G06Q 30/02

(52) U.S. Cl. CPC G06Q 30/0631; G06Q 30/0271; G06Q 30/0201

(57) ABSTRACT

Implementations of the present specification provide a method and apparatus for determining a target user group, where the method includes: determining a seed user of a to-be-recommended product based on association behavior data of a first user for the to-be-recommended product; obtaining a similar user group of the seed user based on user features of the seed user; obtaining a probability score of a second user within the similar user group based on user features of the second user, wherein the probability score indicates a probability that the second user is a target user of the to-be-recommended product; determining probability scores of multiple users, including the second user, satisfy a predetermined condition; based on the probability scores of the multiple users, determining a target user group; and generating a recommendation for the to-be-recommended product to the target user group.

### CROSS-REFERENCE TO RELATED APPLICATIONS

This application is a continuation of PCT Application No. PCT/CN2019/072754, filed on Jan. 23, 2019, which claims priority to Chinese Patent Application No. 201810182272.6, filed on Mar. 6, 2018, and each application is hereby incorporated by reference in its entirety.

### TECHNICAL FIELD

The present specification relates to the field of computer technologies, and in particular, to methods and apparatuses for determining a target user group.

### BACKGROUND

At the time of marketing a specific product, the population to which the product is to be marketed should be determined in advance to the greatest extent. The more accurate the population determination is, the more successful the marketing can be. This can be referred to as population precision marketing. An insurance product is used as an example. An insurance product operator can separately determine a marketing population of each insurance product based on features of different insurance products to be marketed. One insurance product can be marketed to a population A. For another insurance product, the marketing population may change and the product can be marketed to a population B. The precision of the target marketing population can help improve the click through rate and conversion rate in the marketing process, and explore potential user traffic with high efficiency. Therefore, it is important to accurately determine the marketing population before product marketing. This population can be referred to as a target user group.

### SUMMARY

In view of this, the present specification provides methods and apparatuses for determining a target user group, to more accurately determine the target user group.

The one or more implementations of the present specification are implemented by using the following technical solutions:

According to a first aspect, a method for determining a target user group is provided, where the method includes: determining a seed user of a to-be-recommended product based on association behavior data of a user for the to-be-recommended product; obtaining a similar user group of the seed user based on user features of the seed user; obtaining a probability score of each user based on user features of the user in the similar user group, where the probability score is used to indicate the probability that the user is a target user of the to-be-recommended product; and determining multiple users whose probability scores satisfy a predetermined condition as a target user group, so as to recommend the to-be-recommended product to the target user group.

According to a second aspect, an apparatus for determining a target user group is provided, where the apparatus includes: a seed determining module, configured to determine a seed user of a to-be-recommended product based on association behavior data of a user for the to-be-recommended product; a group expansion module, configured to obtain a similar user group of the seed user based on user features of the seed user; a score processing module, configured to obtain a probability score of each user based on user features of the user in the similar user group, where the probability score is used to indicate the probability that the user is a target user of the to-be-recommended product; and a target determining module, configured to determine multiple users whose probability scores satisfy a predetermined condition as a target user group, so as to recommend the to-be-recommended product to the target user group.

According to a third aspect, a device for determining a target user group is provided, where the device includes a memory, a processor, and computer instructions, the computer instructions are stored in the memory and can run on the processor, and the processor executes the instructions to implement the following steps: determining a seed user of a to-be-recommended product based on association behavior data of a user for the to-be-recommended product; obtaining a similar user group of the seed user based on user features of the seed user; obtaining a probability score of each user based on user features of the user in the similar user group, where the probability score is used to indicate the probability that the user is a target user of the to-be-recommended product; and determining multiple users whose probability scores satisfy a predetermined condition as a target user group, so as to recommend the to-be-recommended product to the target user group.

In the method and apparatus for determining a target user group in one or more implementations of the present specification, a similar user group is obtained based on a seed user, so population expansion is implemented, and a magnitude of product recommendation is ensured. In addition, filtering is performed based on probability scores of users of the similar user group, and a user that satisfies a predetermined condition is selected as a target user of a recommended product, so as to ensure quality of a recommended user of the product. A two-stage combination of quantity guarantee and quality guarantee ensures quality of a product advertising population while a magnitude of the population is expanded, and improves positioning accuracy of the target user.

### BRIEF DESCRIPTION OF DRAWINGS

To describe the technical solutions in one or more implementations of the present specification or in the existing technology more clearly, the following briefly describes the accompanying drawings for describing the implementations or the existing technology. Clearly, the accompanying drawings in the following description merely show some implementations described in the one or more implementations of the present specification, and a person of ordinary skill in the art can still derive other drawings from these accompanying drawings without creative efforts.

FIG. 1 is a flowchart illustrating a method for determining a target user group, according to one or more implementations of the present specification;

FIG. 2 shows a seed user determining method, according to one or more implementations of the present specification;

FIG. 3 shows a procedure for calculating a behavior preference value, according to one or more implementations of the present specification;

FIG. 4 shows a procedure for obtaining a similar user group of a seed user, according to one or more implementations of the present specification;

FIG. 5 shows a salient feature determining method, according to one or more implementations of the present specification;

FIG. 6 shows some user features, according to one or more implementations of the present specification;

FIG. 7 is a schematic diagram illustrating a population filtering condition, according to one or more implementations of the present specification;

FIG. 8 is a structural diagram illustrating an apparatus for determining a target user group, according to one or more implementations of the present specification.

### DESCRIPTION OF IMPLEMENTATIONS

To make a person skilled in the art understand the technical solutions in one or more implementations of the present specification better, the following clearly and comprehensively describes the technical solutions in the one or more implementations of the present specification with reference to the accompanying drawings in the one or more implementations of the present specification. Clearly, the described implementations are merely some but not all of the implementations of the present specification. All other implementations obtained by a person of ordinary skill in the art based on the one or more implementations of the present specification without creative efforts shall fall within the protection scope of the present specification.

A method for determining a target user group provided in one or more implementations of the present specification can be used to determine a target marketing user for a specific to-be-recommended product. In the following example, marketing of an insurance product is used as an example to describe the method. However, the method is not limited to the insurance product, and can also be applied to other products or other similar scenarios, for example, directional advertising.

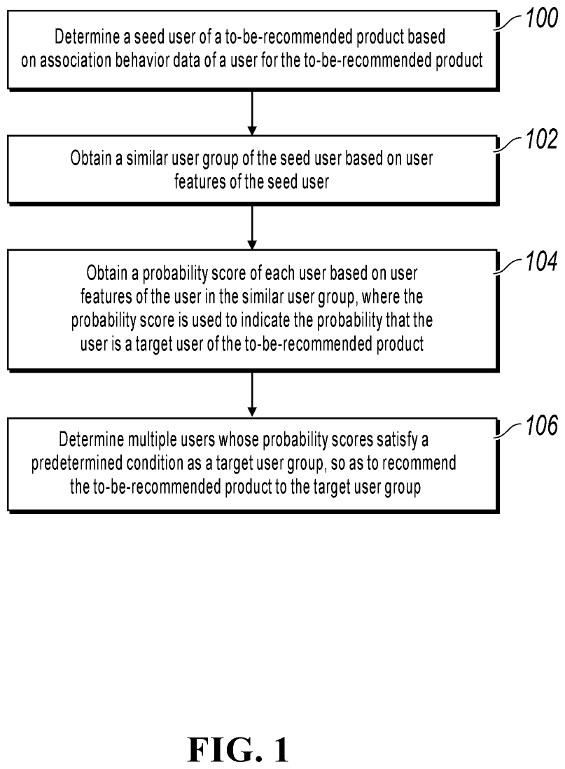

FIG. 1 is a flowchart illustrating a method for determining a target user group, according to one or more implementations of the present specification. The method uses determining of a target user group of insurance product marketing as an example. As shown in FIG. 1, the method can include the following steps:

In step 100, determine a seed user of a to-be-recommended product based on association behavior data of a user for the to-be-recommended product.

In this step, the to-be-recommended product can be an insurance product. The association behavior data of the user for the to-be-recommended product can include, for example, statistical data of the users' behavior such as buying, sharing, or clicking the insurance product. The data can be the times of insurance buying, the times of sharing, the times of clicking, or a click rate. In addition, the association behavior data does not have to be data generated by the user by directly performing an operation on the to-be-recommended product, but can be data related to both the user and the to-be-recommended product in this method. For example, the association behavior data can be data used to estimate the probability whether the user is a target user of the to-be-recommended product. The data can be various payment data of the user, such as purchase of an insurance product, payment of a travel category, payment of riding a shared bicycle, payment of taking a passenger bus, payment of taking a subway, and purchase of an overseas travel product.

A specific to-be-recommended product is used as an example. Association behavior data of the user for the product can include data of different behavior types. For example, “insurance buying” is a behavior type, and association behavior data of the behavior type can be the times of insurance buying. For another example, “clicking” is another behavior type, and association behavior data corresponding to the type can be the times of clicking. Association behavior data of the different behavior types can be integrated to determine whether a user is a seed user of the to-be-recommended product.

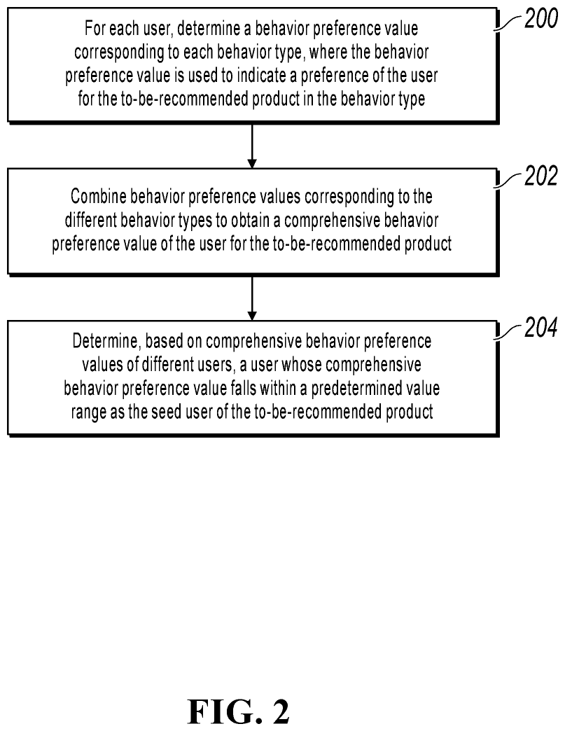

FIG. 2 shows a seed user determining method, according to one or more implementations of the present specification. As shown in FIG. 2, the method can include the following steps:

In step 200, for each user, determine a behavior preference value corresponding to each behavior type, where the behavior preference value is used to indicate a preference of the user for the to-be-recommended product in the behavior type.

Determining the seed user can be determining, from a user group including multiple users, which users are seed users. Then, for each user in the user group, a preference level of the user for the to-be-recommended insurance product in different behavior types can be calculated, and the preference level can be represented by a behavior preference value, which is used to indicate whether the user has sufficient interest in the insurance product in a certain behavior type.

For example, if the behavior preference value of the user in the “insurance buying” behavior is relatively high, it can indicate that the user is likely to buy a relatively large amount of the to-be-recommended insurance product, and can reflect that the user is interested in the product.

For another example, if the behavior preference value of the user in the “sharing” behavior is relatively high, it indicates that the user is sufficiently active in sharing the product and has relatively large sharing times.

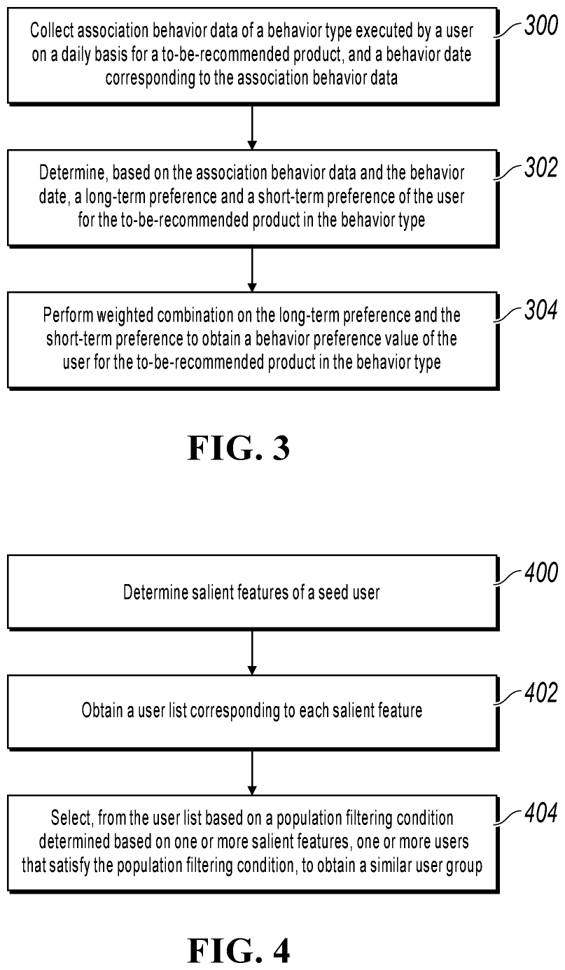

The user's behavior preference value corresponding to each behavior type can be obtained based on unified calculation logic. FIG. 3 shows a procedure for calculating a behavior preference value. The procedure is described by using an example of the “clicking” behavior type, and is also applicable to calculation of the behavior preference value in other behavior types such as “insurance buying” and “clicking”.

In step 300, collect association behavior data of the behavior type executed by the user on a daily basis for the to-be-recommended product, and a behavior date corresponding to the association behavior data.

The data collected in this step can be the times of clicking the to-be-recommended product per day by the user, and an occurrence date of the times of clicking (it is worthwhile to note that the date is an actual occurrence date of the behavior, but not a collection date; for example, if the product is clicked for three times in a day, “3” is generated in this day, and the data may be collected two days later). Table 1 shows an example.

TABLE 1
Association behavior data of click behavior

| Behavior date | Times of clicking |
|---|---|
| 2017 Mar. 15 | 3 |
| 2017 Mar. 16 | 5 |
| . . . | . . . |

In step 302, determine, based on the association behavior data and the behavior date, a long-term preference and a short-term preference of the user for the to-be-recommended product in the behavior type.

In this step, two pieces of data can be calculated for each user, one is long-term preference data weights of the user for the product in a specific behavior type, and the other is short-term preference data weights of the user for the product in the behavior type. The long-term preference data is obtained based on the association behavior data collected in a first time segment, the short-term preference data is obtained based on the association behavior data collected in a second time segment, and the first time segment is greater than the second time segment. For example, data collected in 37 days, i.e., (30+7) days counting forward based on current processing time in the method, is obtained and includes association behavior data in each day (the data collected in step 300). Seven days closest to the current reference time can be referred to as the second time segment, and the other 30 days can be referred to as the first time segment. That is, an arrangement sequence on the time axis can be “the first time segment-the second time segment-the current time”. The previous “30” and “7” are merely examples, are not restrictive, and can be changed.

Both the long-term preference data and the short-term preference data can be calculated based on the following equation (1). The equation can be determining the preference data based on the associated behavior data and the behavior date, performing time weighting on data of different behavior dates, and performing attenuation weighting by time distances.

$$weight\_ipv = \sum \{ insured\_pv \_ 1 d * ( 1 - \frac{diff ( bizdate , ipv\_date )}{data} ) \} \qquad ( 1 )$$

weight_ipv represents the long-term preference data or the short-term preference data, insured_pv_1d represents the association behavior data collected in each day in step 300, bizdate represents a current date, ipv_date represents an occurrence date of insured_pv_1d, data represents the quantity of days in the first time period or the second time period, for example, 30 days or 7 days, and function diff() is used to calculate a day-quantity difference between dates.

After weight_ipv is obtained, logarithmic processing and normalization processing can be further performed.

For example, after weight_ipv is calculated in the previous step, scales of data of different users are greatly different. In terms of service and data processing skills, logarithmic processing needs to be performed on weight_ipv, and a scale of a value range of weight_ipv is narrowed to a reasonable range. A calculation equation can be equation (2).

log_weight_ipv=log_{α}(weight_ipv) (2)

log_weight_ipv represents the logarithm of weight_ipv, log_{α}() represents a logarithmic function, weight_ipv is calculated by using equation (1), and a is the base of the logarithm function.

For another example, log_weight_ipv is obtained after logarithmic processing. However, to improve readability and convenience of use of a result, this indicator can be normalized to an interval (0, 1]. For example, a Min/Max normalization method can be used, and a calculation equation is equation (3):

$$w e i g h {t}_{\{ l , s \}} = \frac{log\_weight \_ipv - min\_log \_weight \_ipv + λ}{max\_log \_weight \_ipv - min\_log \_weight \_ipv + k * λ} \qquad ( 3 )$$

In the equation, Laplacian smoothing λ is added to avoid a case in which x-min=0 or max−min=0, weight_{(l,s)} represents normalized long-term or short-term preference data, min_log_weight_ipv represents a minimum value of log_weight_ipv corresponding to different users, max_log_weight_ipv represents a maximum value of log_weight_ipv corresponding to different users, and k can be, for example, 1 or other values. In step 304, weighted combination is performed on the long-term preference and the short-term preference to obtain the behavior preference value of the user for the to-be-recommended product in the behavior type.

For example, the following equation (4) can be used for combination:

weightₜ=α*weightₗ+(1−α)*weightₛ (4)

In this example, weightₜ represents a behavior preference value of the user for the to-be-recommended product in terms of the click behavior, weightₗ represents a long-term preference of the user for the to-be-recommended product in terms of the click behavior, weightₛ represents a short term preference of the user for the to-be-recommended product in terms of the click behavior, and the long-term preference and the short-term preference can be data that is calculated, logarithmically processed, and normalized by using equation (1). In addition, value setting of a parameter a is a non-trivial process. The parameter a is usually highly dependent on characteristics of data and can be set based on experience. It should be further noted that in different equations of one or more implementations of the present specification, the same parameter a is used in some equations. However, it is not limited that parameters a in different equations must be the same. In different equations, the parameter a can be different. Specific value setting is determined based on an actual situation of each equation.

In step 202, combine behavior preference values corresponding to the different behavior types to obtain a comprehensive behavior preference value of the user for the to-be-recommended product.

After processing in step 200, for each user, behavior preference values for the to-be-recommended product in different behavior types can be obtained. In this step, behavior preference values of the same user in different behavior types can be combined to obtain a comprehensive behavior preference value of the user for the product.

For example, different behavior types include “insurance buying”, “sharing”, “clicking”, “payment record for other travel methods”, and weights of the different behavior types can be separately set during combination. The following Table 2 shows an example.

TABLE 2
Data weights corresponding to behavior types

| Behavior type | Combined weight |
|---|---|
| Insurance buying | 8 |
| Sharing | 4 |
| Clicking | 2 |
| Payment record for travel method | 1 |

According to the weights in the example in Table 2, behavior preference values corresponding to different behavior types of the same user can be combined to obtain a comprehensive behavior preference value of the user for the to-be-recommended product, for example, as shown in Equation (5):

score=Σ(ωᵢ*weightₜ) (5)

score is a comprehensive behavior preference value, weightₜ represents a behavior preference value of the user in a certain behavior type, and ω represents a combined weight corresponding to the behavior type (for example, the weight can be 2̂n (n=0, 1, 2, 3)). A comprehensive behavior preference value for the to-be-recommended product can be obtained for each user. In addition, to ensure that a final comprehensive behavior preference value remains within an interval (0, 1), Min/Max normalization processing can be performed on comprehensive behavior preference values of different users.

In step 204, determine, based on comprehensive behavior preference values of different users, a user whose comprehensive behavior preference value falls within a predetermined value range as the seed user of the to-be-recommended product.

For example, a predetermined value range can be set. If a comprehensive behavior preference value of a user falls within the predetermined value range, the user can be determined as the seed user of the to-be-recommended product.

There can be multiple finally obtained seed users.

In step 102, obtain a similar user group of the seed user based on user features of the seed user.

After seed users are obtained in step 100, population expansion can be performed based on these seed users, to help an operator of an insurance product explore more potential user traffic to satisfy a population magnitude need of product advertising. In this step, the similar user group of the seed user can be searched for based on the seed user.

For example, the similar user group of the seed user can be obtained based on the procedure shown in FIG. 4:

In step 400, determine a salient feature of the seed user.

For example, the seed user can have multiple features such as a population attribute, a social/life attribute, behavior habits, and interests and preferences, and from these features, a feature that can clearly distinguish the seed user from a common user can be selected as the salient feature of the seed user.

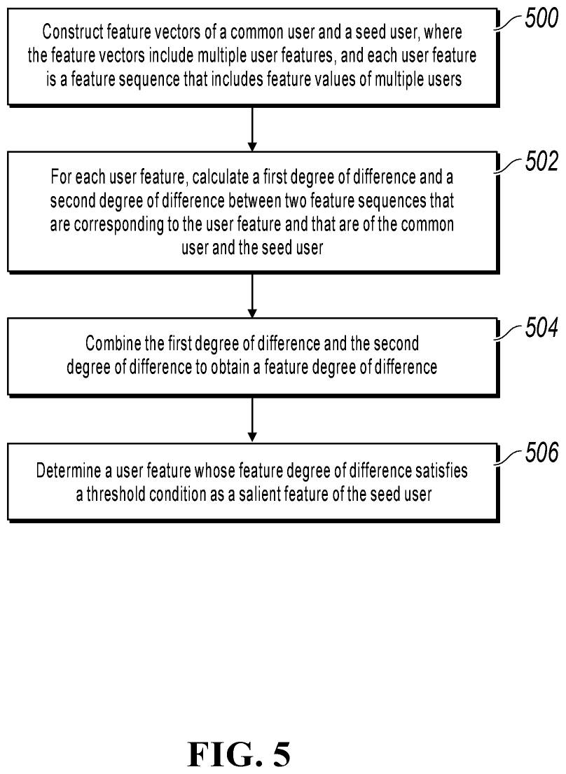

The following FIG. 5 illustrates a salient feature determining method, which can include the following processing:

In step 500, construct feature vectors of a common user and the seed user, where the feature vectors include multiple user features, and each user feature is a feature sequence that includes feature values of multiple users.

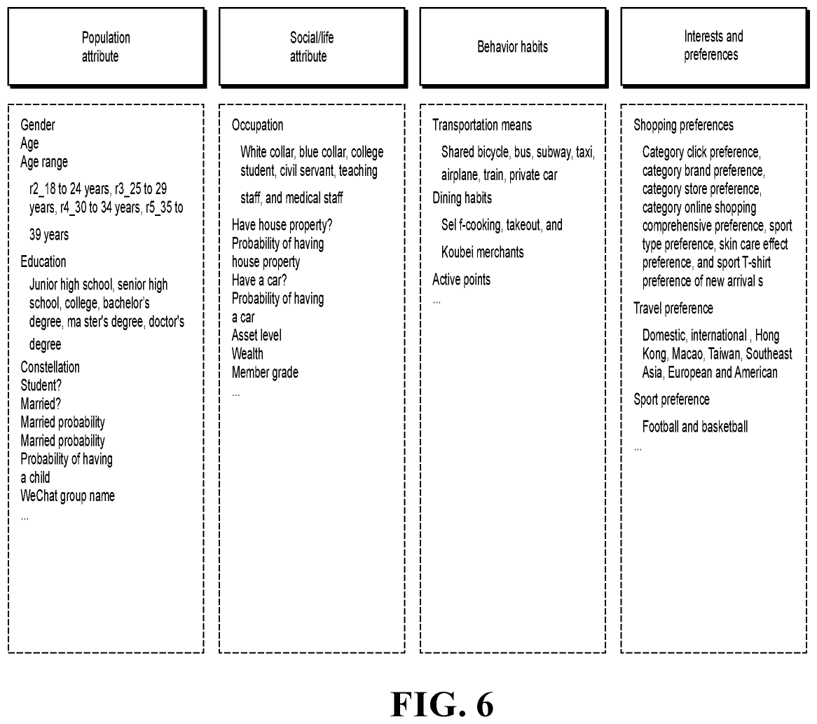

FIG. 6 illustrates some user features, which can include population attributes such as gender, age, and education, further include social/life attributes such as occupation, house property, car possession, and asset class, further include behavior habits such as transportation means, dietary habits, and further include interests and preferences such as shopping preferences, travel preferences, and sports preferences.

In this step, a feature vector can be constructed with reference to the user features in the example in FIG. 6.

For example, a feature vector U_F_{{s,c}}={F₁, F₂, . . . , Fₖ, . . . , Fₙ}={v₁, v₂, . . . , vₖ, . . . , vₙ} is constructed, where U_Fₛ represents a feature vector of a seed user, U_F_{c} represents a feature vector of a common user, and the quantity of common users and the quantity of seed users can be 1:1. The feature vector can include multiple user features, such as F₁, F₂, and Fₖ, each of which is a user feature. Each user feature can be a feature sequence that includes feature values of multiple users. For example, v₁, v₂, and vₖ are different feature values that belong to the same user feature.

For example, assume that there are 500 seed users and 500 common users. Feature vectors of the seed users are {F₁, F₂, . . . , Fₙ}, where F₁ is a user feature, for example, can be “age”. F₁ is a feature sequence {v₁, v₂, . . . , vₙ}, where each feature value is age of each of the 500 seed users, and these ages can be sorted in descending order.

In step 502, for each user feature, calculate a first degree of difference and a second degree of difference between two feature sequences that are corresponding to the user feature and that are of the common user and the seed user.

As described above, each user feature in the feature vector is a feature sequence. For each user feature, two feature sequences can be obtained, one is a feature sequence of the seed user, and the other is a feature sequence of the common user. In this step, different degree of difference calculation methods can be used to calculate the degree of differences between the two feature sequences.

For example, a degree of difference between the two feature sequences of the seed user and the common user can be obtained based on cosine similarity, which is denoted as F_DIFF_{cosine}, and the degree of difference can be referred to as the first degree of difference. As shown in Equation (6):

$${F\_DIFF}_{c o s i n e} = \frac{{U\_F}_{s , {F}_{i}} {•U\_F}_{c , {F}_{i}}}{\vert {U\_F}_{s , {F}_{i}} \vert \vert {U\_F}_{c , {F}_{i}} \vert} \qquad ( 6 )$$

U_F_{s,F}_{ᵢ} represents a feature sequence of a certain user feature of the seed user, and U_F_{c,F}_{ᵢ} represents a feature sequence of the same user feature of the common user.

For example, a degree of difference between the two feature sequences of the seed user and the common user can be obtained based on the Smith Waterman algorithm, which is denoted as F_DIFF_{smithwaterman}, and the degree of difference can be referred to as the second degree of difference. As shown in Equation (7):

F_DIFF_{smithwaterman}=smithwaterman(U_F_{s,F}_{ᵢ}, U_F_{c,F}_{ᵢ}) (7)

U_F_{s,F}_{ᵢ} represents a feature sequence of a certain user feature of the seed user, and U_F_{c,F}_{ᵢ} represents a feature sequence of the same user feature of the common user.

In step 504, combine the first degree of difference and the second degree of difference to obtain a feature degree of difference.

For example, the calculation can be performed based on Equation (8):

diff_{F}=a*F_DIFF_{cosine}+(1−α)*F_DIFF_{smithwaterman} (8)

F_DIFF_{cosine} represents a first degree of difference of a certain feature, F_DIFF_{smithwaterman} represents a second degree of difference of the same feature, and diff_{F} represents a feature degree of difference of the feature. The feature degree of difference can be used to indicate a difference between the seed user and the common user in terms of the feature.

In step 506, determine a user feature whose feature degree of difference satisfies a threshold condition as a salient feature of the seed user.

For example, the threshold condition can be set, and a user feature whose feature degree of difference value satisfies the threshold condition is determined as a salient feature of the seed user. In terms of this salient feature, the seed user and the common user have a relatively obvious difference. For example, there can be multiple finally obtained salient features.

In step 402, obtain a user list corresponding to each salient feature.

For example, the user list corresponding to each salient feature can be found by using an inverted table based on the obtained salient features. The following Table 3 shows an example.

TABLE 3
Feature-User correspondence table

| Salient feature | User list |
|---|---|
| feature 1 | user1 user2 |
| feature 2 | user3 user4 user5 |
| . . . | . . . |

In step 404, select, from the user list based on a population filtering condition determined based on one or more salient features, one or more users that satisfy the population filtering condition, to obtain the similar user group.

In this step, the user list obtained in step 402 can be further filtered to obtain one or more users that satisfy the population filtering condition as the similar user group of the seed user.

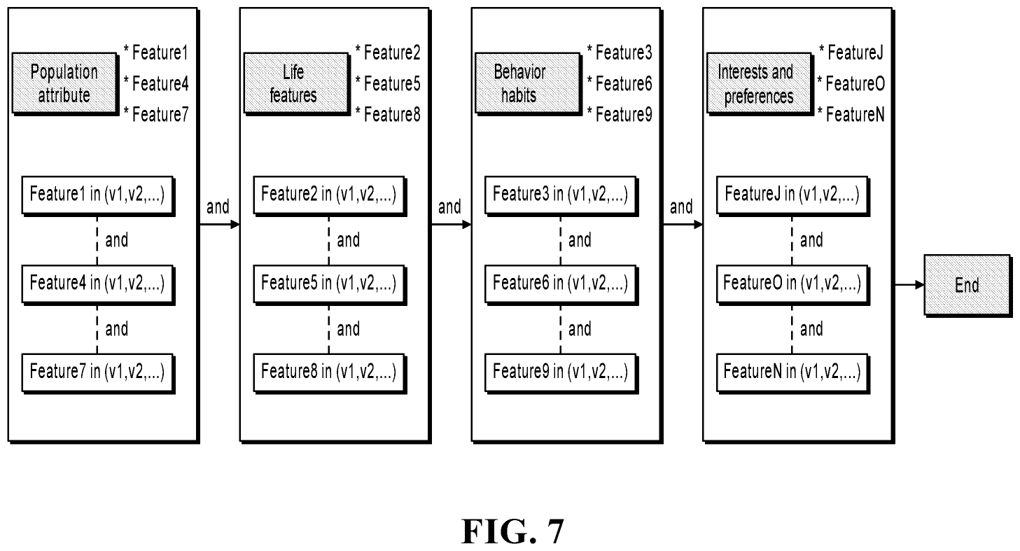

The population filtering condition can be obtained based on selected at least some salient features and a condition combination between the salient features. The following is described by using an example with reference to FIG. 7. As shown in FIG. 7, assume that salient features: feature 1, feature 4, and feature 7 are features of a population attribute, and feature 2, feature 5, and feature 8 are life features, etc. “and” in FIG. 7 indicates that when a user is selected, a feature of the user needs to have each salient feature associated by “and”.

For example, “feature 1 and feature 4 and feature 7” indicates that the selected user needs to have the three features at the same time. Similarly, if “feature 1 and feature 4” and “feature 2 and feature 5” exist, the user needs to have feature 1 and feature 4 in the population attribute and have feature 2 and feature 5 in the life feature.

In addition, the magnitude of the similar user group can be controlled by setting the population filtering condition. For example, if the quantity of similar user groups is to be expanded, the quantity of salient features can be reduced. For example, feature 7 in the population attribute is removed, or a combination condition between salient features is reduced, for example, salient features associated by “and” are reduced. That is, if the filtering condition is broadened, a population magnitude can be expanded. Similarly, when the quantity of similar user groups needs to be reduced, the quantity of salient features or the feature combination in the condition can be increased.

In step 104, obtain a probability score of each user based on user features of the user in the similar user group, where the probability score is used to indicate the probability that the user is a target user of the to-be-recommended product.

In this step, each user in the similar user group can be scored based on a scoring model.

The scoring model can be based on the feature vector constructed in step 500, that is, comprehensive scoring is performed based on multiple features of a user, and a score can be used to indicate the probability whether a user is a target user of the to-be-recommended insurance product.

For example, a probability score of a user can be predicted based on a regression model:

$$p ( clk \vert U\_F ) = \frac{1}{1 + {\overline{e}}^{U\_F * a}} \qquad ( 9 )$$

U_F is a feature vector of the user, clk indicates clicking, and a is a hyperparameter and is mainly used to adjust a prediction score range. In addition, the scoring model used in this step is not limited to the previous regression model, and other models can also be used, for example, a deep neural network (DNN) and ensemble learning.

In step 106, determine multiple users whose probability scores satisfy a predetermined condition as a target user group, so as to recommend the to-be-recommended product to the target user group.

For example, users can be sorted by the probability scores, and one or more users sorted at predetermined locations can be selected to obtain the target user group.

For another example, one or more users whose probability scores satisfy a predetermined threshold range can be used as the target user group.

In the method for determining a target user group in this example, a similar user group is obtained based on a seed user, so population expansion is implemented, and a magnitude of product recommendation is ensured. In addition, a scoring model is also used to score and filter users of the similar user group, and a user with a high score is selected as a target user of a recommended product, so as to ensure quality of a recommended user of the product. A two-stage combination of quantity guarantee and quality guarantee ensures quality of a product advertising population while a magnitude of the population is expanded, and improves positioning accuracy of the target user.

In addition, in a process of extracting the salient feature of the seed user, salient feature extraction is more accurate by using multiple degree of difference calculation methods. For example, the salient feature can be found by using a Smith Waterman sequence difference with a strong denoising capability and Cosine similarity linear weighting. Certainly, other degree of difference algorithms can also be used in actual implementation. In addition, saliency feature extraction in this method does not depend on manual annotation and does not need prior knowledge. In addition, the saliency feature extraction method has good portability, and can easily be extended to other scenarios, such as directional advertising. In addition, at the time of obtaining the salient feature, all user features in the feature vector can be used, that is, all features participate in calculation instead of some features. A simple similarity idea used as such is very direct, and because of a traversal calculation method, less information loss is generated during calculation.

In addition, in the method, the seed user is determined by combining multiple types of association behavior data of the users, so the seed user can be more accurately determined, and the similar user group obtained based on seed user expansion is also better. In addition, at the time of scoring a user in the similar user group, multiple features of the user can be combined to obtain a probability score, and a probability that the user is a target user can be more accurately evaluated.

In addition, the method can further facilitate control of population coverage and advertising effects. For example, population coverage can be controlled by using a population filtering condition, and advertising effects can be sorted by probability scores or can be controlled based on a threshold.

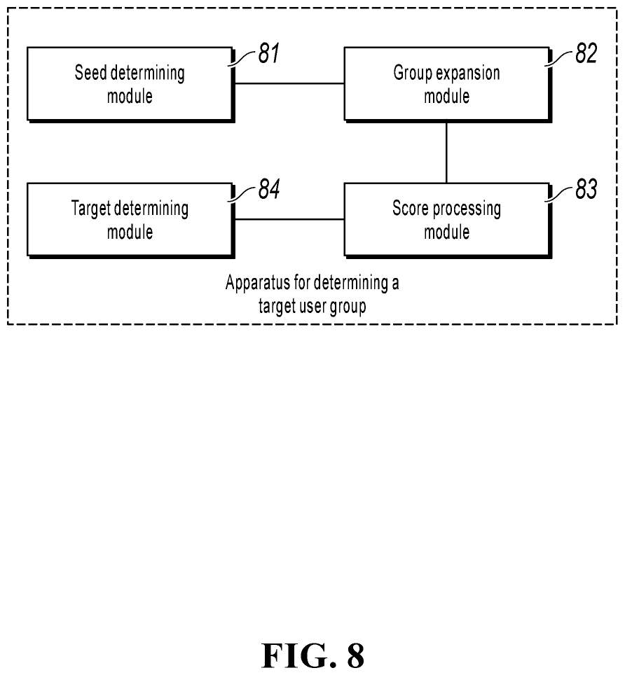

To implement the previous method, one or more implementations of the present specification further provide an apparatus for determining a target user group. As shown in FIG. 8, the apparatus can include a seed determining module 81, a group expansion module 82, a score processing module 83, and a target determining module 84.

The seed determining module 81 is configured to determine a seed user of a to-be-recommended product based on association behavior data of a user for the to-be-recommended product; the group expansion module 82 is configured to obtain a similar user group of the seed user based on user features of the seed user; the score processing module 83 is configured to obtain a probability score of each user based on user features of the user in the similar user group, where the probability score is used to indicate the probability that the user is a target user of the to-be-recommended product; and the target determining module 84 is configured to determine multiple users whose probability scores satisfy a predetermined condition as a target user group, so as to recommend the to-be-recommended product to the target user group.

In an example, the seed determining module 81 is specifically configured to: when the association behavior data includes association behavior data of different behavior types, for each user, determine a behavior preference value corresponding to each behavior type, where the behavior preference value is used to indicate a preference of the user for the to-be-recommended product in the behavior type; combine behavior preference values corresponding to the different behavior types to obtain a comprehensive behavior preference value of the user for the to-be-recommended product; and determine, based on comprehensive behavior preference values of different users, a user whose comprehensive behavior preference value falls within a predetermined value range as the seed user of the to-be-recommended product.

In an example, when the seed determining module 81 is configured to determine the behavior preference value corresponding to each behavior type of the user, the following is included: collecting association behavior data of the behavior type executed by the user on a daily basis for the to-be-recommended product, and a behavior date corresponding to the association behavior data; determining, based on the association behavior data and the behavior date, a long-term preference and a short-term preference of the user for the to-be-recommended product in the behavior type, where the long-term preference is obtained based on the association behavior data collected in a first time segment, the short-term preference is obtained based on the association behavior data collected in a second time segment, and the first time segment is greater than the second time segment; and performing weighted combination on the long-term preference and the short-term preference to obtain the behavior preference value of the user for the to-be-recommended product in the behavior type.

In an example, the group expansion module 82 is specifically configured to: construct feature vectors of a common user and the seed user, where the feature vectors include multiple user features, and each user feature is a feature sequence that includes feature values of multiple users; for each user feature, calculate a first degree of difference and a second degree of difference between two feature sequences that are corresponding to the user feature and that are of the common user and the seed user, where the first degree of difference and the second degree of difference are obtained by using different degree of difference calculation methods; combine the first degree of difference and the second degree of difference to obtain a feature degree of difference, and determine a user feature whose feature degree of difference satisfies a threshold condition as a salient feature of the seed user; and determine the similar user group of the seed user based on the salient feature.

For ease of description, the previous apparatuses are described by dividing the functions into various modules. Certainly, in the one or more implementations of the present specification, a function of each module can be implemented in one or more pieces of software and/or hardware.

An execution sequence of the steps in the procedure of the method implementation is not limited to a sequence in the flowchart. In addition, descriptions of steps can be implemented as a form of software, hardware, or a combination thereof. For example, a person skilled in the art can implement the descriptions in a form of software code, and the code can be a computer executable instruction that can implement logical functions corresponding to the steps. When implemented in a software form, the executable instruction can be stored in a memory and executed by a processor in a device.

For example, corresponding to the previous method, one or more implementations of the present specification provide a device for determining a target user group, where the device can include a memory, a processor, and computer instructions, the computer instructions are stored in the memory and can run on the processor, and the processor executes the instructions to implement the following steps: determining a seed user of a to-be-recommended product based on association behavior data of a user for the to-be-recommended product; obtaining a similar user group of the seed user based on user features of the seed user; obtaining a probability score of each user based on user features of the user in the similar user group, where the probability score is used to indicate the probability that the user is a target user of the to-be-recommended product; and determining multiple users whose probability scores satisfy a predetermined condition as a target user group, so as to recommend the to-be-recommended product to the target user group.

The apparatuses or modules described in the previous implementations can be implemented by a computer chip or an entity, or can be implemented by a product with a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

A person skilled in the art should understand that one or more implementations of the present application can be provided as a method, a system, or a computer program product. Therefore, the one or more implementations of the present specification can use a form of hardware only implementations, software only implementations, or implementations with a combination of software and hardware. In addition, the one or more implementations of the present specification can use a form of a computer program product that is implemented on one or more computer-usable storage media (including but not limited to a disk memory, a CD-ROM, an optical memory, etc.) that include computer-usable program code.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so a series of operations and operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

The one or more implementations of the present specification can be described in common contexts of computer executable instructions executed by a computer, such as a program module. Generally, the program module includes a routine, a program, a target, a component, a data structure, etc. executing a specific task or implementing a specific abstract data type. The one or more implementations of the present specification can also be practiced in distributed computing environments. In the distributed computing environments, tasks are performed by remote processing devices that are connected through a communications network. In a distributed computing environment, the program module can be located in both local and remote computer storage media including storage devices.

The implementations in the present specification are described in a progressive way. For same or similar parts of the implementations, references can be made to the implementations. Each implementation focuses on a difference from other implementations. Particularly, a server device implementation is similar to a method implementation, and therefore is described briefly. For related parts, references can be made to related descriptions in the method implementation.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or may be advantageous.

The previous descriptions are merely preferred implementations of one or more implementations of the present specification, but are not intended to limit the present specification. Any modification, equivalent replacement, or improvement made without departing from the spirit and principle of the present specification shall fall within the protection scope of the present specification.

What is claimed is:

1. A computer-implemented method comprising:
determining a seed user of a to-be-recommended product based on association behavior data of a first user for the to-be-recommended product;
obtaining a similar user group of the seed user based on user features of the seed user;
obtaining a probability score of a second user within the similar user group based on user features of the second user, wherein the probability score indicates a probability that the second user is a target user of the to-be-recommended product;
determining probability scores of multiple users, including the second user, satisfy a predetermined condition;
based on the probability scores of the multiple users, determining a target user group; and
generating a recommendation for the to-be-recommended product to the target user group.

2. The computer-implemented method of claim 1, wherein the association behavior data comprises data of different behavior types, and wherein determining the seed user of the to-be-recommended product based on the association behavior data of the first user for the to-be-recommended product comprises:
for the first user, determining one or more behavior preference values corresponding to one or more behavior types, wherein the one or more behavior preference values are used to indicate a preference of the first user within a group of one or more other users for the to-be-recommended product in the behavior type;
combining the one or more behavior preference values corresponding to the one or more behavior types to obtain a comprehensive behavior preference value of the first user for the to-be-recommended product;
determining the comprehensive behavior preference value of the first user is within a predetermined value range; and
based on the comprehensive behavior preference value, determining the first user as the seed user of the to-be-recommended product.

3. The computer-implemented method of claim 2, wherein a behavior preference value of the one or more behavior preference values corresponding to a first behavior type of the one or more behavior types of the first user is obtained by using the following method:
collecting association behavior data of the first behavior type executed by the first user on a daily basis for the to-be-recommended product, and a first behavior date corresponding to the association behavior data;
determining, based on the association behavior data and the first behavior date, a long-term preference and a short-term preference of the first user for the to-be-recommended product in the behavior type, wherein the long-term preference is obtained based on the association behavior data collected in a first time segment, the short-term preference is obtained based on the association behavior data collected in a second time segment, and the first time segment is greater than the second time segment; and
performing weighted combination on the long-term preference and the short-term preference to obtain the behavior preference value of the first user for the to-be-recommended product in the behavior type.

4. The computer-implemented method of claim 1, wherein obtaining the similar user group of the seed user based on user features of the seed user comprises:
constructing feature vectors of a common user and the seed user, wherein the feature vectors comprise multiple user features, and each user feature of the user features is a feature sequence that comprises feature values of multiple users;
for each user feature, calculating a first degree of difference and a second degree of difference between two feature sequences that correspond to a user feature of the common user and the seed user, wherein the first degree of difference and the second degree of difference are obtained by using different degree of difference calculation methods;
combining the first degree of difference and the second degree of difference to obtain a feature degree of difference, and determining a user feature whose feature degree of difference satisfies a threshold condition as a salient feature of the seed user; and
determining the similar user group of the seed user based on the salient feature.

5. The computer-implemented method of claim 4, wherein the first degree of difference is obtained based on a cosine similarity algorithm and the second degree of difference is obtained based on a Smith-Waterman algorithm.

6. The computer-implemented method of claim 4, wherein there are one or more salient features, and wherein determining the similar user group of the seed user based on the salient feature comprises:
obtaining a user list corresponding to each salient feature of one or more salient features;
determining a population filtering condition based on the one or more salient features, wherein the population filtering condition is obtained based on at least the one or more salient features and a condition combination between the one or more salient features; and
selecting, from the user list, one or more users that satisfy the population filtering condition, to determine the similar user group.

7. The computer-implemented method of claim 1, wherein determining the target user group comprises:
sorting the multiple users by the probability scores and selecting one or more of the multiple users based on a result of sorting the multiple users.

8. The computer-implemented method of claim 1, wherein determining the target user group comprises:
selecting one or more of the multiple users based on the probability scores and a predetermined threshold range.

9. A non-transitory, computer-readable medium storing one or more instructions executable by a computer system to perform operations comprising:
determining a seed user of a to-be-recommended product based on association behavior data of a first user for the to-be-recommended product;
obtaining a similar user group of the seed user based on user features of the seed user;
obtaining a probability score of a second user within the similar user group based on user features of the second user, wherein the probability score indicates a probability that the second user is a target user of the to-be-recommended product;
determining probability scores of multiple users, including the second user, satisfy a predetermined condition;
based on the probability scores of the multiple users, determining a target user group; and
generating a recommendation for the to-be-recommended product to the target user group.

10. The non-transitory, computer-readable medium of claim 9, wherein the association behavior data comprises data of different behavior types, and wherein determining the seed user of the to-be-recommended product based on the association behavior data of the first user for the to-be-recommended product comprises:
for the first user, determining one or more behavior preference values corresponding to one or more behavior types, wherein the one or more behavior preference values are used to indicate a preference of the first user within a group of one or more other users for the to-be-recommended product in the behavior type;
combining the one or more behavior preference values corresponding to the one or more behavior types to obtain a comprehensive behavior preference value of the first user for the to-be-recommended product;
determining the comprehensive behavior preference value of the first user is within a predetermined value range; and
based on the comprehensive behavior preference value, determining the first user as the seed user of the to-be-recommended product.

11. The non-transitory, computer-readable medium of claim 10, wherein a behavior preference value of the one or more behavior preference values corresponding to a first behavior type of the one or more behavior types of the first user is obtained by using the following method:
collecting association behavior data of the first behavior type executed by the first user on a daily basis for the to-be-recommended product, and a first behavior date corresponding to the association behavior data;
determining, based on the association behavior data and the first behavior date, a long-term preference and a short-term preference of the first user for the to-be-recommended product in the behavior type, wherein the long-term preference is obtained based on the association behavior data collected in a first time segment, the short-term preference is obtained based on the association behavior data collected in a second time segment, and the first time segment is greater than the second time segment; and
performing weighted combination on the long-term preference and the short-term preference to obtain the behavior preference value of the first user for the to-be-recommended product in the behavior type.

12. The non-transitory, computer-readable medium of claim 9, wherein obtaining the similar user group of the seed user based on user features of the seed user comprises:
constructing feature vectors of a common user and the seed user, wherein the feature vectors comprise multiple user features, and each user feature of the user features is a feature sequence that comprises feature values of multiple users;
for each user feature, calculating a first degree of difference and a second degree of difference between two feature sequences that correspond to a user feature of the common user and the seed user, wherein the first degree of difference and the second degree of difference are obtained by using different degree of difference calculation methods;
combining the first degree of difference and the second degree of difference to obtain a feature degree of difference, and determining a user feature whose feature degree of difference satisfies a threshold condition as a salient feature of the seed user; and
determining the similar user group of the seed user based on the salient feature.

13. The non-transitory, computer-readable medium of claim 12, wherein the first degree of difference is obtained based on a cosine similarity algorithm and the second degree of difference is obtained based on a Smith-Waterman algorithm.

14. The non-transitory, computer-readable medium of claim 12, wherein there are one or more salient features, and wherein determining the similar user group of the seed user based on the salient feature comprises:
obtaining a user list corresponding to each salient feature of one or more salient features;
determining a population filtering condition based on the one or more salient features, wherein the population filtering condition is obtained based on at least the one or more salient features and a condition combination between the one or more salient features; and
selecting, from the user list, one or more users that satisfy the population filtering condition, to determine the similar user group.

15. The non-transitory, computer-readable medium of claim 9, wherein determining the target user group comprises:
sorting the multiple users by the probability scores and selecting one or more of the multiple users based on a result of sorting the multiple users.

16. The non-transitory, computer-readable medium of claim 9, wherein determining the target user group comprises:
selecting one or more of the multiple users based on the probability scores and a predetermined threshold range.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining a seed user of a to-be-recommended product based on association behavior data of a first user for the to-be-recommended product;
obtaining a similar user group of the seed user based on user features of the seed user;
obtaining a probability score of a second user within the similar user group based on user features of the second user, wherein the probability score indicates a probability that the second user is a target user of the to-be-recommended product;
determining probability scores of multiple users, including the second user, satisfy a predetermined condition;
based on the probability scores of the multiple users, determining a target user group; and
generating a recommendation for the to-be-recommended product to the target user group.

18. The computer-implemented system of claim 17, wherein the association behavior data comprises data of different behavior types, and wherein determining the seed user of the to-be-recommended product based on the association behavior data of the first user for the to-be-recommended product comprises:
for the first user, determining one or more behavior preference values corresponding to one or more behavior types, wherein the one or more behavior preference values are used to indicate a preference of the first user within a group of one or more other users for the to-be-recommended product in the behavior type;
combining the one or more behavior preference values corresponding to the one or more behavior types to obtain a comprehensive behavior preference value of the first user for the to-be-recommended product;
determining the comprehensive behavior preference value of the first user is within a predetermined value range; and
based on the comprehensive behavior preference value, determining the first user as the seed user of the to-be-recommended product.

19. The computer-implemented system of claim 18, wherein a behavior preference value of the one or more behavior preference values corresponding to a first behavior type of the one or more behavior types of the first user is obtained by using the following method:
collecting association behavior data of the first behavior type executed by the first user on a daily basis for the to-be-recommended product, and a first behavior date corresponding to the association behavior data;
determining, based on the association behavior data and the first behavior date, a long-term preference and a short-term preference of the first user for the to-be-recommended product in the behavior type, wherein the long-term preference is obtained based on the association behavior data collected in a first time segment, the short-term preference is obtained based on the association behavior data collected in a second time segment, and the first time segment is greater than the second time segment; and
performing weighted combination on the long-term preference and the short-term preference to obtain the behavior preference value of the first user for the to-be-recommended product in the behavior type.

20. The computer-implemented system of claim 17, wherein obtaining the similar user group of the seed user based on user features of the seed user comprises:
constructing feature vectors of a common user and the seed user, wherein the feature vectors comprise multiple user features, and each user feature of the user features is a feature sequence that comprises feature values of multiple users;
for each user feature, calculating a first degree of difference and a second degree of difference between two feature sequences that correspond to a user feature of the common user and the seed user, wherein the first degree of difference and the second degree of difference are obtained by using different degree of difference calculation methods;
combining the first degree of difference and the second degree of difference to obtain a feature degree of difference, and determining a user feature whose feature degree of difference satisfies a threshold condition as a salient feature of the seed user; and
determining the similar user group of the seed user based on the salient feature.

21. The computer-implemented system of claim 20, wherein the first degree of difference is obtained based on a cosine similarity algorithm and the second degree of difference is obtained based on a Smith-Waterman algorithm.

22. The computer-implemented system of claim 20, wherein there are one or more salient features, and wherein determining the similar user group of the seed user based on the salient feature comprises:
obtaining a user list corresponding to each salient feature of one or more salient features;
determining a population filtering condition based on the one or more salient features, wherein the population filtering condition is obtained based on at least the one or more salient features and a condition combination between the one or more salient features; and
selecting, from the user list, one or more users that satisfy the population filtering condition, to determine the similar user group.

23. The computer-implemented system of claim 17, wherein determining the target user group comprises:
sorting the multiple users by the probability scores and selecting one or more of the multiple users based on a result of sorting the multiple users.

24. The computer-implemented system of claim 17, wherein determining the target user group comprises:
selecting one or more of the multiple users based on the probability scores and a predetermined threshold range.
